(19) United States
(12) Patent Application Publication
(10) Pub. No.: US 2014/0320478 A1
(43) Pub. Date: Oct. 30, 2014

(54) Display Device For Low Speed Drive And Method For Driving The Same

(71) Applicant: LG Display Co., Ltd., Seoul (KR)

(72) Inventors: Daeseok OH, Paju-si (KR); Bogun SEO, Paju-si (KR); Yonghwa PARK, Paju-si (KR)

(73) Assignee: LG Display Co., Ltd., Seoul (KR)

(21) Appl. No.: 14/263,720

(22) Filed: Apr. 28, 2014

(30) Foreign Application Priority Data
Apr. 30, 2013 (KR) 10-2013-0048383

(51) Int. Cl. G09G 3/00

(52) U.S. Cl. CPC G09G 3/00; G09G 2330/021; G09G 2230/00
USPC 345/212

(57) ABSTRACT

A display device for low speed drive includes a display panel formed with gate lines and data lines intersecting the gate lines, wherein a pixel is defined by each crossing of the gate lines and the data lines, a source driver supplying a data voltage to the data lines, a gate driver supplying a gate pulse to the gate lines, and a timing controller which time-divides one frame of received data into n sub-frames, where n is a positive integer equal to or greater than 4, groups the gate lines into n gate groups, controls the gate driver to scan the n gate groups in scan sub-frames corresponding to a portion of the n sub-frames, and control the scan order of the n gate groups in a zigzag form.

### CROSS-REFERENCE TO RELATED APPLICATION

This application claims priority under 35 U.S.C. §119(a) to Korean Patent Application No. 10-2013-0048383 filed on Apr. 30, 2013, which is incorporated herein by reference in its entirety.

### BACKGROUND OF THE INVENTION

1. Field of the Invention

Embodiments of the invention relate to a display device for low speed drive and a method for driving the same.

2. Discussion of the Related Art

Display devices have been used in various display units, such as portable information devices, office devices, computers, and televisions. A display device includes a display panel for displaying an image and a driver for driving the display panel. A plurality of data lines and a plurality of gate lines are formed on the display panel, and pixels are respectively formed at crossings of the data lines and the gate lines. The driver includes a source driver for driving the data lines and a gate driver for driving the gate lines.

Various methods for reducing power consumption of the display device are known, one of which is a low speed driving technology. Low speed driving technology refreshes the entire screen of the display device at a frame frequency less than an input frame frequency. Low speed driving technology may be implemented through a skip drive shown in FIG. 1. The skip drive time-divides one frame into a plurality of sub-frames, scans all of the gate lines in a first sub-frame of the plurality of sub-frames to refresh an image on the entire screen of the display device, and maintains the refreshed image in remaining sub-frames (i.e., the frames excluding the first sub-frame from the plurality of sub-frames).

For example, as shown in FIG. 1, when an image is input from a host at an input frame frequency of 60 Hz, the display device divides one frame into first to eighth sub-frames SF1 to SF8 as shown in FIG. 2. The display device scans all of the gate lines in the first sub-frame SF1 to refresh the image on the entire screen of the display device and maintains the refreshed image in the second to eighth sub-frames SF2 to SF8, thereby driving the display panel at a frame frequency of 7.5 Hz.

The frame frequency indicates the number of frames driven per second. In general, the display device operates with reduced consumption current as the frame frequency decreases. However, as the frame frequency decreases, a refresh period of the screen lengthens. Therefore, a drop in pixel voltage resulting from a leakage current Ioff of a thin film transistor (TFT) can be observed at a low frame frequency with the naked eyes. As a result, a reduction in the image quality, such as a heavy flicker, may appear.

As shown in FIG. 3, a pixel voltage Vp gradually decreases due to the leakage current Ioff of the TFT generated at a gate off-time until a gate pulse SP again increases to an on-level (i.e., a gate high voltage). In FIG. 3, “Vdata” denotes a data voltage, and “Vcom” denotes a common voltage. The data voltage Vdata swings based on the common voltage Vcom in a cycle of one frame period and implements a polarity inversion drive. When the data voltage Vdata is greater than the common voltage Vcom, a positive pixel voltage Vp occurs. On the contrary, when the data voltage Vdata is less than the common voltage Vcom, a negative pixel voltage Vp occurs.

In the low frequency driving technology using the skip drive shown in FIG. 2, a luminance deviation between sub-frames of the same frame increases due to the leakage current Ioff of the TFT, and as a result, the flicker is easily visible. In FIG. 4, all of the pixels are charged in the first sub-frame SF1, and then the data charging is stopped in the second to eighth sub-frames SF2 to SF8. Therefore, the pixel voltages Vp have a maximum potential in the first sub-frame SF1 and have a minimum potential in the eighth sub-frame SF8. For example, in a typical system, a voltage magnitude per one gray level in a liquid crystal driven at 8V is 0.03V (8V/256 gray levels), and a drop in the pixel voltage Vp caused by the leakage current Ioff of the TFT is 0.5V. In this instance, a luminance deviation between the first sub-frame SF1 and the eighth sub-frame SF8 may correspond to several tens of gray levels. Therefore, the luminance deviation may be visible as flicker.

### SUMMARY OF THE INVENTION

Embodiments of the invention provide a display device for low speed drive and a method for driving the same capable of preventing or greatly reducing perceivable flicker during a low speed drive.

In one embodiment, a display device for low speed drive comprises a display panel formed with a plurality of gate lines and a plurality of data lines intersecting the plurality of gate lines, wherein a pixel is defined by each crossing of the gate lines and the data lines, a source driver configured to supply data voltages to the data lines, a gate driver configured to supply a gate pulse to the gate lines, and a timing controller configured to time-divide each frame of received data into n sub-frames, where n is a positive integer equal to or greater than 4, group the gate lines into n gate groups, control an operation of the gate driver to scan the n gate groups in scan sub-frames corresponding to a portion of the n sub-frames, and control the scan order of the n gate groups to scan the n gate groups in a zigzag form.

In an embodiment, the gate lines are grouped into the n gate groups based on position within a block of n adjacent gate lines. The block of n adjacent gate lines comprises one or more sub-blocks of gate lines wherein one gate line is scanned in each sub-block in each of the scan sub-frames. The timing controller is further configured to control the scan order of the n gate groups in the zigzag form such that within each sub-block, a line position corresponding to a gate line being scanned alternately increases and decreases between consecutive scan sub-frames.

In an embodiment, the timing controller controls the gate driver to scan the gate lines according to the scan order such that gate lines scanned in any given scan sub-frame are non-adjacent.

In an embodiment, the timing controller controls the gate drive to skip a scan operation of all of the gate groups is skipped in skip sub-frames corresponding to remaining sub-frames excluding the scan sub-frames from the n sub-frames. At least one of the skip sub-frames is disposed between every adjacent scan sub-frames.

In an embodiment, at least two gate groups are scanned in each of the scan sub-frames.

In an embodiment, the n sub-frames include first, third, fifth, and seventh sub-frames corresponding to the scan sub-frames and second, fourth, sixth, and eighth sub-frames corresponding to skip sub-frames and the gate lines are grouped into first to eighth gate groups. The timing controller controls the gate driver to scan the second and sixth gate groups in the first sub-frame, scan the third and seventh gate groups in the third sub-frame, scan the first and fifth gate groups in the fifth sub-frame, and scan the fourth and eighth gate groups in the seventh sub-frame.

In an embodiment, the n sub-frames include first, third, fifth, and seventh sub-frames corresponding to the scan sub-frames and second, fourth, sixth, and eighth sub-frames corresponding to skip sub-frames and the gate lines are grouped into first to eighth gate groups. The timing controller controls the gate driver to scan the third and seventh gate groups in the first sub-frame, scan the second and sixth gate groups in the third sub-frame, scan the fourth and eighth gate groups in the fifth sub-frame, and scan the first and fifth gate groups in the seventh sub-frame.

In an embodiment, the source driver supplies the data voltages to the data lines during the scan frames and does not supply the data voltages to the data lines in the skip sub-frames corresponding to sub-frames other than the n scan sub-frames.

In another embodiment, there is a method for driving a display device for low speed drive including a display panel formed with a plurality of gate lines and a plurality of data lines intersecting the plurality of gate lines, wherein a pixel is defined by each crossing of the gate lines and the data lines, a source driver supplying data voltages to the data lines, and a gate driver supplying a gate pulse to the gate lines, the method comprising time-dividing one frame of received data into n sub-frames, where n is a positive integer equal to or greater than 4, and grouping the gate lines into n gate groups, and controlling the gate driver to dividedly scan the n gate groups in scan sub-frames corresponding to only a portion of the n sub-frames and controlling the scan order of the n gate groups in a zigzag form.

In another embodiment, a display device for low speed drive comprises a display panel formed with a plurality of gate lines and a plurality of data lines intersecting the plurality of gate lines, wherein a pixel is defined by each crossing of the gate lines and the data lines, a gate driver configured to supply a gate pulse to the gate lines, and a timing controller configured to receive data arranged in a sequence of frames, to time-divide a frame from the sequence of frames into a sequence of n sub-frames, wherein the n sub-frames includes a sequence of scan sub-frames interleaved with a sequence of skip sub-frames, to group the gate lines into n gate groups based on position within a block of n adjacent gate lines, the block of n adjacent gate lines comprising one or more sub-blocks of gate lines wherein the timing controller controls the gate drive to scan one gate line in each sub-block in each of the scan sub-frames, and to control the gate driver to scan the gate lines according to a scan order such that such that within each sub-block, a line position corresponding to a gate line being scanned alternately increases and decreases between consecutive scan sub-frames.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates changes in a frame frequency during a skip drive, as compared with a normal drive;

FIG. 2 shows an example of a conventional skip drive;

FIG. 3 is a waveform diagram illustrating a drop in pixel voltage resulting from a leakage current of a thin film transistor;

FIG. 4 is a waveform diagram illustrating a drop in pixel voltage, resulting in perceivable image distortion in a conventional skip drive;

FIG. 5 is a block diagram of a display device for low speed drive according to an exemplary embodiment of the invention;

FIG. 6 shows an example of a frame that is time-divided into n sub-frames for dividedly scanning gate groups in some scan sub-frames of the n sub-frames;

FIG. 7 shows an example of one or more skip sub-frames inserted between scan sub-frames according to an exemplary embodiment of the invention;

FIGS. 8 and 9 are diagrams showing an example of a zigzag scan and interlaced skip drive according to an exemplary embodiment of the invention;

FIG. 10 is a waveform diagram illustrating a distribution effect of a luminance deviation on each line through a zigzag scan and interlaced skip drive according to an exemplary embodiment of the invention, as compared with a conventional skip drive;

FIGS. 11 and 12 are diagrams showing additional examples of a zigzag scan and interlaced skip drive according to an exemplary embodiment of the invention; and

FIG. 13 shows measured results of flicker levels according to an exemplary embodiment of the invention, as compared with conventional display devices.

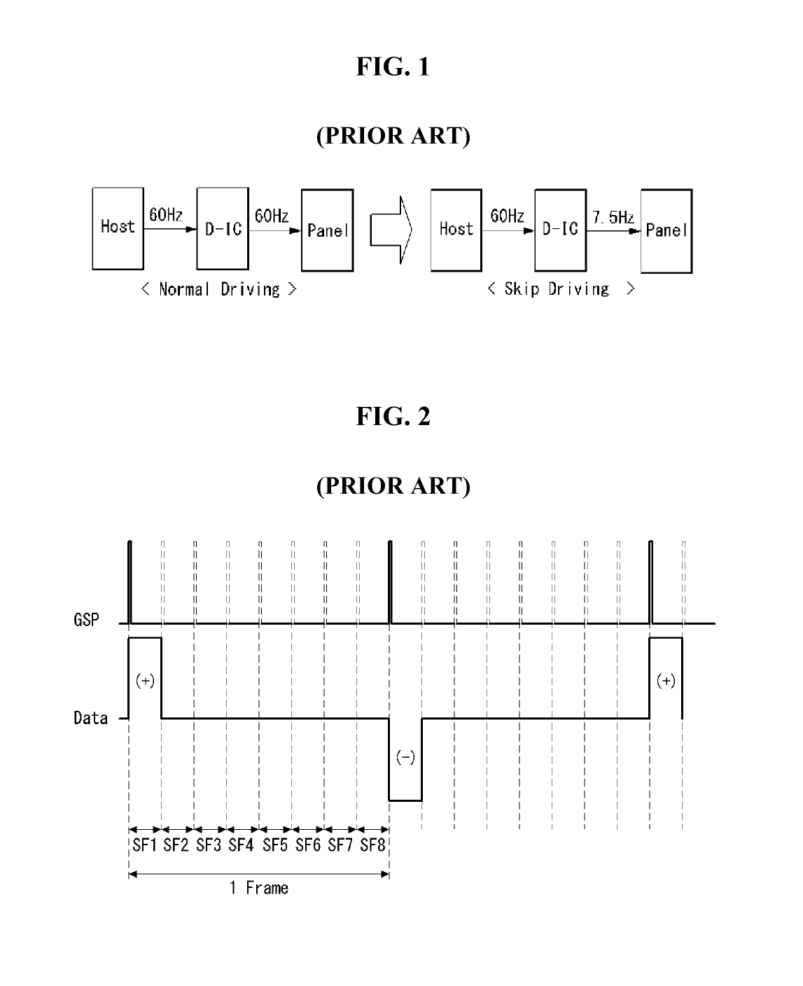

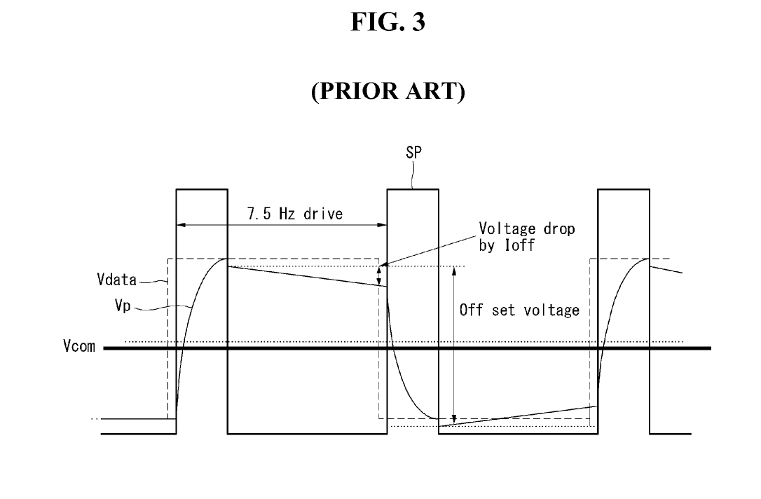

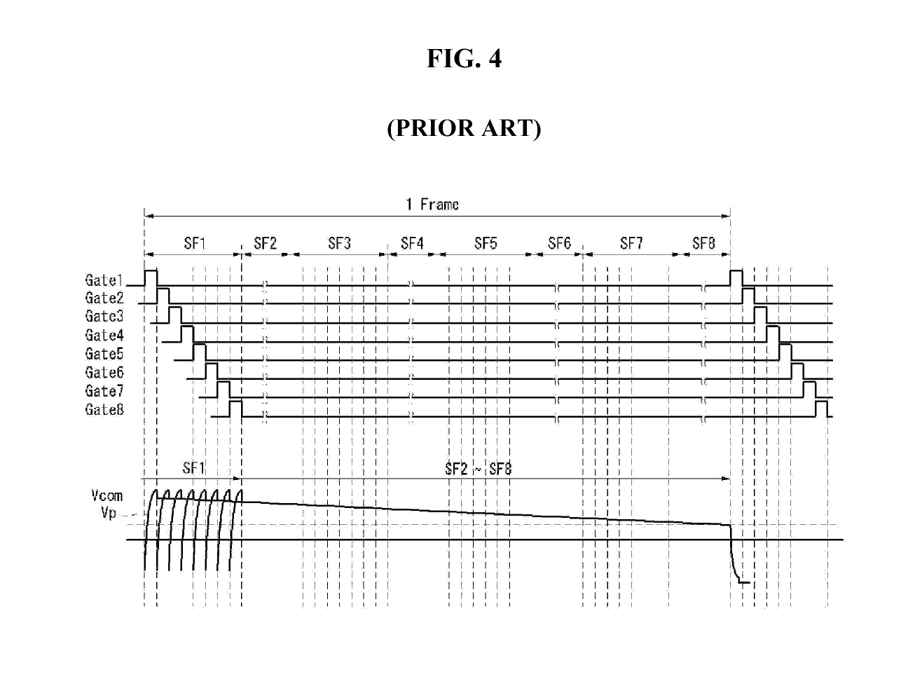

### DETAILED DESCRIPTION OF THE ILLUSTRATED EMBODIMENTS

Reference will now be made in detail to embodiments of the invention, examples of which are illustrated in the accompanying drawings. Wherever possible, the same reference numbers will be used throughout the drawings to refer to the same or like parts. It will be paid attention that detailed description of known arts will be omitted if it is determined that the arts can mislead the embodiments of the invention.

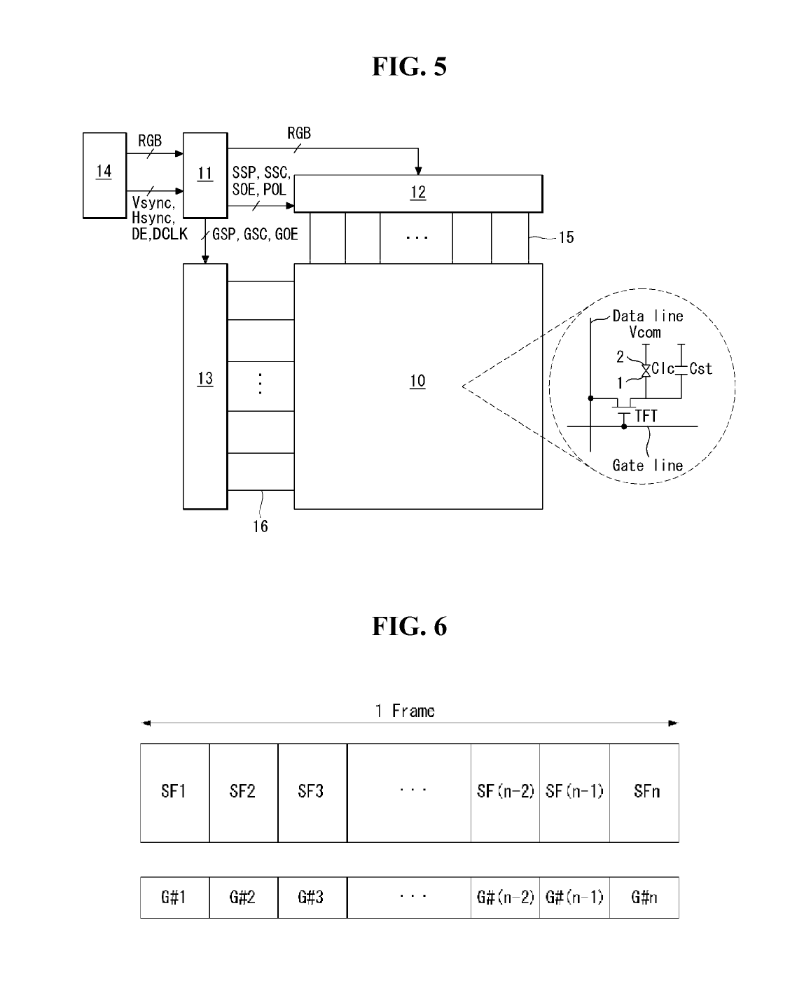

Exemplary embodiments of the invention will be described with reference to FIGS. 5 to 13.

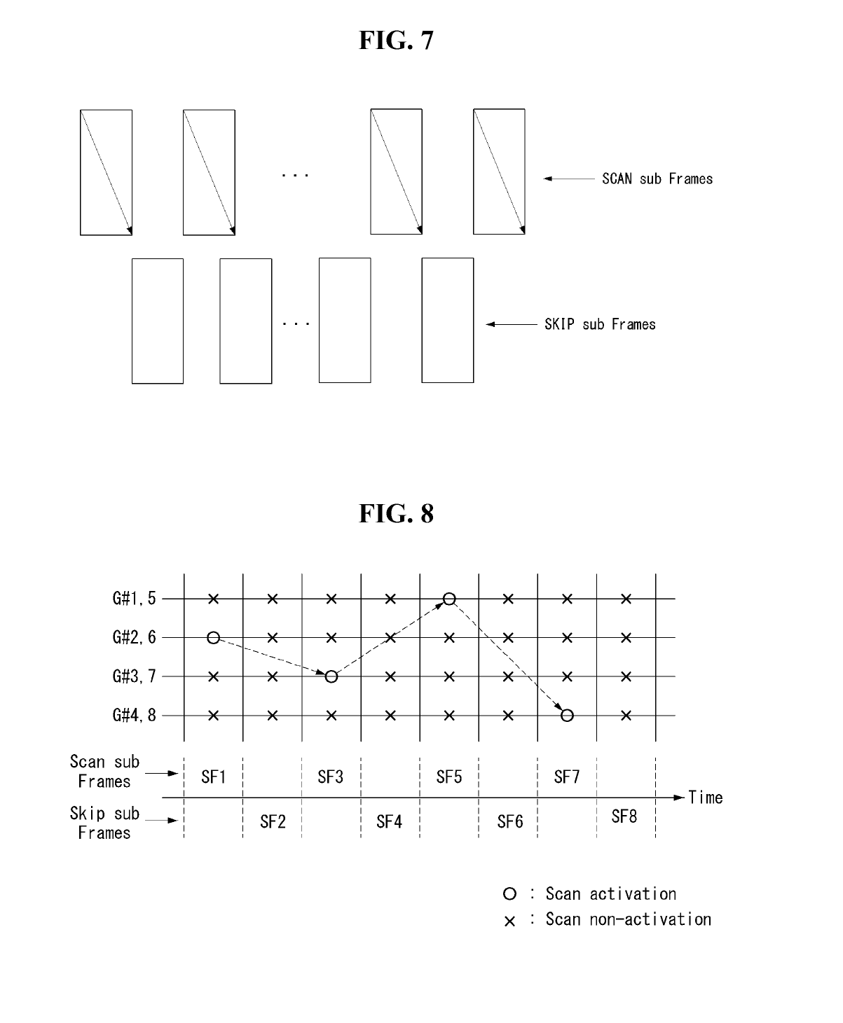

FIG. 5 is a block diagram of a display device for low speed drive according to an exemplary embodiment of the invention. FIG. 6 shows an example of a frame that is time-divided into n sub-frames for dividedly scanning gate groups in some scan sub-frames of the n sub-frames. FIG. 7 shows an example of one or more skip sub-frames inserted between scan sub-frames according to the embodiment of the invention.

As shown in FIG. 5, the display device for low speed drive according to the embodiment of the invention may be implemented as a flat panel display, such as a liquid crystal display (LCD), a field emission display (FED), a plasma display panel (PDP), an organic light emitting display, or an electrophoresis display (EPD). In the following description, the embodiment of the invention will be described using the liquid crystal display as an example of the flat panel display. Other flat panel displays may be used.

A liquid crystal display panel 10 includes a lower glass substrate, an upper glass substrate, and a liquid crystal layer formed between the lower glass substrate and the upper glass substrate. The liquid crystal display panel 10 includes liquid crystal cells Clc which are arranged in a matrix form based on a crossing structure of data lines 15 and gate lines 16.

A pixel array is formed on the lower glass substrate of the liquid crystal display panel 10. The pixel array includes the liquid crystal cells (i.e., pixels) Clc formed at crossings of the data lines 15 and the gate lines 16, thin film transistors (TFTs) connected to pixel electrodes 1 of the pixels, common electrodes 2 positioned opposite the pixel electrodes 1, and storage capacitors Cst. Each liquid crystal cell Clc is connected to the TFT and is driven by an electric field between the pixel electrode 1 and the common electrode 2. Black matrixes, red, green, and blue color filters, etc. are formed on the upper glass substrate of the liquid crystal display panel 10. Polarizing plates are respectively attached to the upper and lower glass substrates of the liquid crystal display panel 10. Alignment layers for setting a pre-tilt angle of liquid crystals are respectively formed on the upper and lower glass substrates of the liquid crystal display panel 10.

The common electrodes 2 are formed on the upper glass substrate in a vertical electric field driving manner such as a twisted nematic (TN) mode and a vertical alignment (VA) mode. The common electrodes 2 are formed on the lower glass substrate along with the pixel electrodes 1 in a horizontal electric field driving manner such as an in-plane switching (IPS) mode and a fringe field switching (FFS) mode.

The liquid crystal display panel 10 applicable to the embodiment of the invention may be implemented in any liquid crystal mode including the TN mode, the VA mode, the IPS mode, the FFS mode, etc. The liquid crystal display according to the embodiment of the invention may be implemented as any type liquid crystal display including a transmissive liquid crystal display, a transflective liquid crystal display, or a reflective liquid crystal display. The transmissive liquid crystal display and the transflective liquid crystal display require a backlight unit. The backlight unit may be implemented as a direct type backlight unit or an edge type backlight unit.

The timing controller 11 receives digital video data RGB of an input image from a host system 14 through a low voltage differential signaling (LVDS) interface and supplies the digital video data RGB of the input image to a source driver 12 through a mini LVDS interface. The timing controller 11 arranges the digital video data RGB received from the host system 14 in conformity with a disposition configuration of the pixel array and then supplies the arranged digital video data RGB to the source driver 12.

The timing controller 11 receives timing signals, such as a vertical sync signal Vsync, a horizontal sync signal Hsync, a data enable signal DE, and a dot clock DCLK, from the host system 14 and generates control signals for controlling operation timings of the source driver 12 and a gate driver 13. The control signals include a gate timing control signal for controlling operation timing of the gate driver 13 and a source timing control signal for controlling operation timing of the source driver 12.

The gate timing control signal includes a gate start pulse GSP, a gate shift clock GSC, a gate output enable signal GOE, etc. The gate start pulse GSP is applied to a gate driver integrated circuit (IC) generating a first gate pulse and controls the gate driver ICs so that the first gate pulse is generated. The gate shift clock GSC is also input to gate driver ICs of the gate driver 13 and shifts the gate start pulse GSP. The gate output enable signal GOE controls an output of the gate driver ICs.

The source timing control signal includes a source start pulse SSP, a source sampling clock SSC, a polarity control signal POL, a source output enable signal SOE, etc. The source start pulse SSP controls data sampling start timing of the source driver 12. The source sampling clock SSC controls sampling timing of data in the source driver 12 based on its rising or falling edge. The polarity control signal POL controls polarities of the data voltages sequentially output from each of source driver ICs of the source driver 12. The source output enable signal SOE controls output timing of the source driver 12.

The embodiment of the invention prevents or substantially reduces flicker, which is a problem in conventional low speed drive technology, through a zigzag scan and interlaced skip drive. For this, the timing controller 11 controls an operation of the source driver 12 and an operation of the gate driver 13, so that the zigzag scan and interlaced skip drive is implemented. The timing controller 11 properly generates the gate timing control signal and the source timing control signal, so that the digital video data RGB input at a frame frequency of 60 Hz may be refreshed in the pixel array of the liquid crystal display panel 10 based on a frame frequency of 60/n Hz, where n is a positive integer.

In one embodiment, the timing controller 11 receives data arranged in a sequence of frames. As shown in FIG. 6, the timing controller 11 time-divides one frame of received data into n sub-frames SF1 to SFn and also groups the gate lines 16 into n gate groups G#1 to G#n, where n is a positive integer equal to or greater than 4, so as to implement the zigzag scan drive. In one embodiment, the gate lines 16 are divided into gate groups G#1 to G#n based on position within a block of n adjacent gate lines 16. For example, in one embodiment, gate group G#1 includes the first gate line in each block, gate group G#2 includes the second gate line in each block, and so on. The timing controller 11 controls the the gate driver 13 to dividedly scan the n gate groups G#1 to G#n in scan sub-frames corresponding to only a portion of the n sub-frames SF1 to SFn. For example, in one embodiment, the n sub-frames SF1 to SFn comprises a sequence of scans sub-frames interleaved with a sequence of skip sub-frames. Each of the sequence of scan sub-frames is associated with at least one of the gate groups G#1 to G#n indicating which gate lines 16 to scan during each of the sequence of scan sub-frames. Furthermore, the blocks may comprise one or more sub-blocks of gate lines. For example, in the case where n=8, a first sub-block may include the first to fourth gate lines (in groups G#1 to G#4) and the second sub-block may include the fifth to eighth gate lines (in groups G#5 to G#8). In an embodiment, the timing controller 11 controls the gate driver 13 to scan one gate line in each sub-block in each of the scan sub-frames (thus multiple gate groups may be scanned in each scan sub-frame). In this instance, the timing controller 11 controls the scan order of the gate groups G#1 to G#n to scan the n gate groups in a zigzag form. For example, in one embodiment of the zigzag form, the timing controller 11 controls the gate driver 13 to scan the gate lines 16 according to a scan order such that within each sub-block, a line position corresponding to a gate line being scanned alternately increases and decreases between consecutive scan sub-frames. Further, as shown in FIG. 7, the timing controller 11 may assign at least one skip sub-frame between every adjacent scan sub-frames, so as to implement the interlaced skip drive. The skip sub-frame corresponds to remaining sub-frames excluding the scan sub-frames from the n sub-frames SF1 to SFn. In the skip sub-frames, the timing controller 11 controls the gate drive 13 to skip a scan operation of all of the gate groups G#1 to G#n is skipped.

The timing controller 11 activates the scan operation of the gate lines 16 in the scan sub-frames and also inactivates the scan operation of the gate lines 16 in the skip sub-frames in response to the gate timing control signal. The timing controller 11 activates a data voltage supply operation of the source driver 12 in the scan sub-frames to supply the data voltage to the data lines and also inactivates the data voltage supply operation of the source driver 12 in the skip sub-frames to not supply the data voltages to the data lines in response to the source timing control signal.

The source driver 12 includes a shift register, a latch array, a digital-to-analog converter, an output circuit, and the like. The source driver 12 latches the digital video data RGB in response to the source timing control signal and converts the latched digital video data RGB into positive and negative analog gamma compensation voltages. The source driver 12 then supplies the data voltages, of which polarities are inverted every a predetermined period of time, to the data lines 15 through a plurality of output channels.

The gate driver 13 supplies the gate pulse to the gate lines 16 in response to the gate timing control signal using a shift register and a level shifter through the above-described zigzag scan and interlaced skip drive. The shift register of the gate driver 13 may be directly formed on the lower glass substrate of the liquid crystal display panel 10 through a gate driver-in panel (GIP) process.

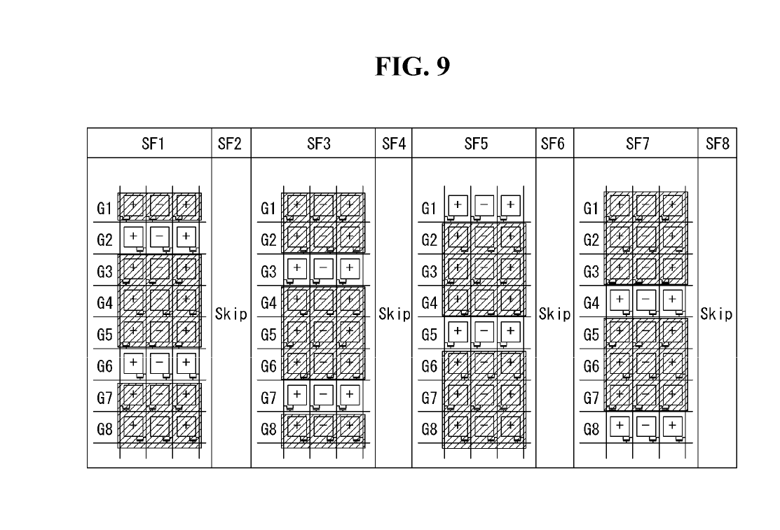

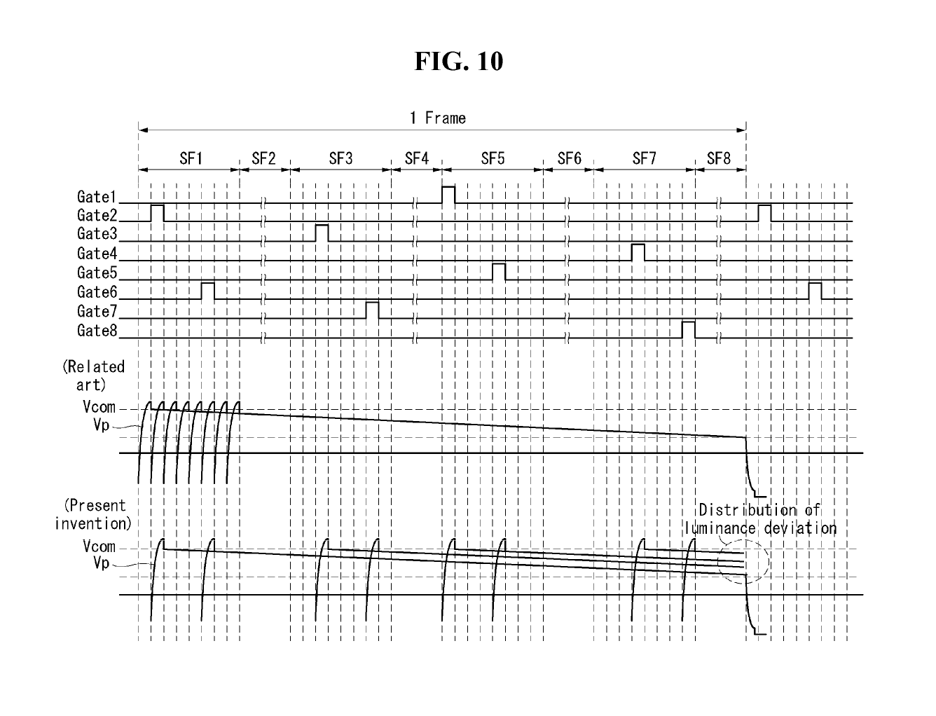

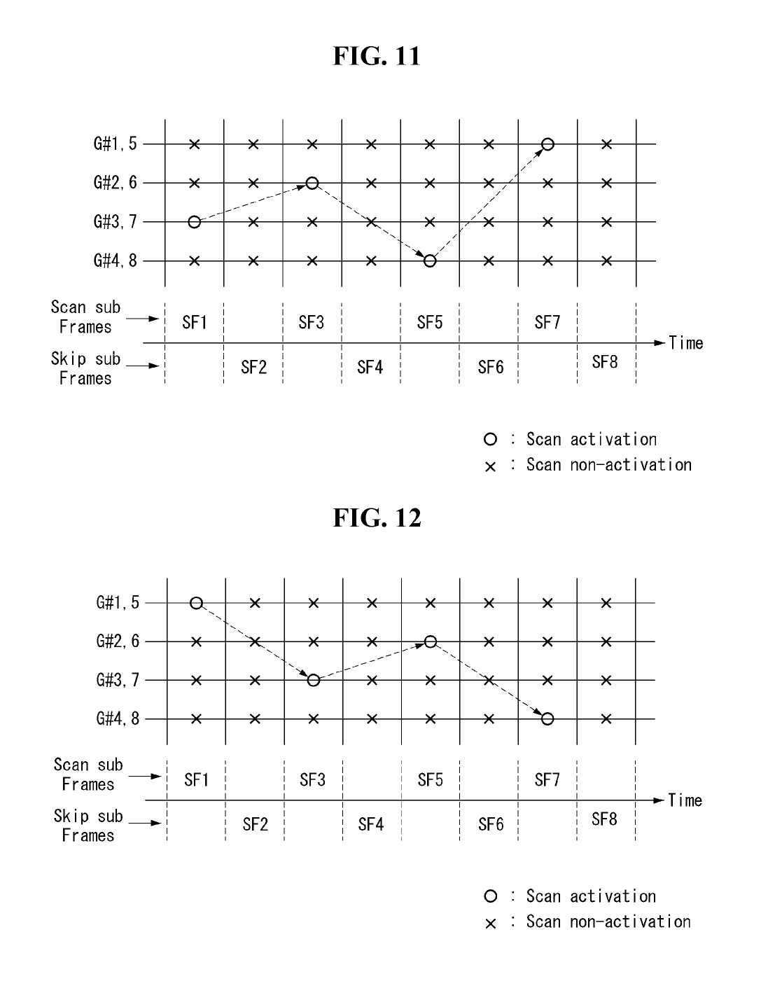

FIGS. 8 and 9 are diagrams showing an example of the zigzag scan and interlaced skip drive according to the embodiment of the invention. FIG. 10 is a waveform diagram illustrating a distribution effect of a luminance deviation on each line through the zigzag scan and interlaced skip drive according to the embodiment of the invention, as compared with the a conventional skip drive. FIGS. 11 and 12 are diagrams showing additional examples of the zigzag scan and interlaced skip drive according to the embodiment of the invention.

As shown in FIGS. 8 and 9, the embodiment of the invention may display digital video data, which is input in synchronization with the frame frequency of 60 Hz, on the liquid crystal display panel 10 in synchronization with the frame frequency of 7.5 Hz through the zigzag scan and interlaced skip drive according to the embodiment of the invention.

The embodiment of the invention time-divides one frame into eight sub-frames SF1 to SF8 and also groups the gate lines 16 into eighth gate groups G#1 to G#8. The eight sub-frames SF1 to SF8 include four scan sub-frames SF1, SF3, SF5, and SF7 and four skip sub-frames SF2, SF4, SF6, and SF8. For an interlaced skip drive, each of the skip sub-frames SF2, SF4, SF6, and SF8 may be disposed between adjacent scan sub-frames. As described above, in the skip sub-frames SF2, SF4, SF6, and SF8, the data voltage supply operation of the source driver 12 and a gate group scan operation of the gate driver 14 are skipped.

As shown in FIGS. 8 and 9, the embodiment of the invention distributes and scans the eight gate groups G#1 to G#8 only in the four scan sub-frames SF1, SF3, SF5, and SF7. In this instance, the two gate groups are assigned to each of the four scan sub-frames SF1, SF3, SF5, and SF7, and the scan order of the gate groups G#1 to G#8 is controlled in the zigzag form.

In the embodiment disclosed herein, the first gate group G#1 includes (8m+1)th gate lines G1, G9, G17, . . . , where m is a non-negative integer; the second gate group G#2 includes (8m+2)th gate lines G2, G10, G18, . . . ; the third gate group G#3 includes (8m+3)th gate lines G3, G11, G19, . . . ; the fourth gate group G#4 includes (8m+4)th gate lines G4, G12, G20, . . . ; the fifth gate group G#5 includes (8m+5)th gate lines G5, G13, G21, . . . ; the sixth gate group G#6 includes (8m+6)th gate lines G6, G14, G22, . . . ; the seventh gate group G#7 includes (8m+7)th gate lines G7, G15, G23, . . . ; and the eighth gate group G#8 includes (8m+8)th gate lines G8, G16, G24, . . . .

As an example of implementing the zigzag scan drive, the embodiment of the invention may sequentially scan the second and sixth gate groups G#2 and G#6 in the first sub-frame SF1, then sequentially scan the third and seventh gate groups G#3 and G#7 in the third sub-frame SF3, then sequentially scan the first and fifth gate groups G#1 and G#5 in the fifth sub-frame SF5, and then sequentially scan the fourth and eighth gate groups G#4 and G#8 in the seventh sub-frame SF7.

As another example of implementing the zigzag scan drive as illustrated in FIG. 11, the embodiment of the invention may sequentially scan the third and seventh gate groups G#3 and G#7 in the first sub-frame SF1, then sequentially scan the second and sixth gate groups G#2 and G#6 in the third sub-frame SF3, then sequentially scan the fourth and eighth gate groups G#4 and G#8 in the fifth sub-frame SF5, and then sequentially scan the first and fifth gate groups G#1 and G#5 in the seventh sub-frame SF7.

As another example of implementing the zigzag scan drive as illustrated in FIG. 12, the embodiment of the invention may sequentially scan the first and fifth gate groups G#1 and G#5 in the first sub-frame SF1, then sequentially scan the third and seventh gate groups G#3 and G#7 in the third sub-frame SF3, then sequentially scan the second and sixth gate groups G#2 and G#6 in the fifth sub-frame SF5, and then sequentially scan the fourth and eighth gate groups G#4 and G#8 in the seventh sub-frame SF7.

In addition, there are several other methods for implementing the zigzag scan drive according to the embodiment of the invention. The methods illustrated in FIGS. 8 and 11 may be more preferable in some embodiments, for distributing a line deviation effect in a manner such that flicker is unperceivable.

As shown in FIG. 10, the embodiment of the invention may distribute a luminance deviation every eight lines through the above-described zigzag scan drive. In the related art, all of the gate lines were scanned in the first sub-frame SF1, and data was written in the first sub-frame SF1. In the remaining sub-frames SF2 to SF8, the written data was held. Hence, a large luminance deviation was caused between the first sub-frame SF1 and the eighth sub-frame SF8 in the related art. On the other hand, in the embodiment of the invention, the gate lines are dividedly scanned in the four scan sub-frames, and the scan order of the gate lines is controlled in the zigzag form. Hence, the luminance deviation is distributed every eight lines, and the flicker is reduced as compared with the related art. In other words, the gate lines are scanned in a scan order such that the gate lines scanned in any given scan sub-frame are non-adjacent. In this state, the embodiment of the invention disposes at least one skip sub-frame between every adjacent scan sub-frames, so as to implement the interlaced skip drive. As a result, the low speed driving technology, in which the flicker is not visible, may be implemented. When one skip sub-frame is disposed between every adjacent scan sub-frames as in the embodiment of the invention, power consumption is reduced by about 40% based on a single color of 15 Hz, as compared with the related art.

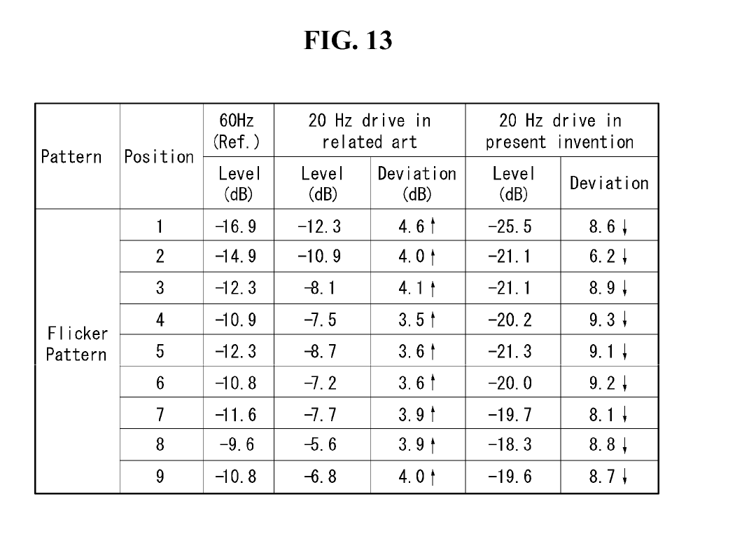

FIG. 13 shows measured results of flicker levels according to the embodiment of the invention, as compared with conventional skip drive technology.

As shown in FIG. 13, in an experiment for measuring a flicker level, a flicker pattern, in which a black pattern and a white pattern were alternated with each other based on column line, was displayed on a display panel, and the flicker level was measured at nine positions. According to the experiment, the flicker level at respective measurement positions based on the related art 20 Hz skip drive increased as compared with a normal drive of 60 Hz. On the other hand, the flicker level at respective measurement positions based the zigzag scan and interlaced skip drive according to the embodiment of the invention was reduced as compared with the normal drive of 60 Hz. For example, the flicker level of the related art at a center position increased by about 3.6 dB from the normal drive of −12.3 dB and was degraded to about −8.7 dB. On the other hand, the flicker level in the embodiment of the invention was reduced by about 9.1 dB from the normal drive of −12.3 dB and was improved to about −21.3 dB.

As described above, the embodiment of the invention dividedly scans the n gate groups in the scan sub-frames corresponding to only a portion of the n sub-frames and controls the scan order of the n gate groups in the zigzag form. Further, the embodiment of the invention assigns at least one skip sub-frame between every adjacent scan sub-frames to implement the low speed drive. Hence, the embodiment of the invention may efficiently suppress the flicker during the low speed drive while reducing the power consumption.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display device for low speed drive comprising:
a display panel formed with a plurality of gate lines and a plurality of data lines intersecting with the plurality of gate lines, wherein a pixel is defined by each crossing of the gate lines and the data lines;
a source driver configured to supply data voltages to the data lines;
a gate driver configured to supply a gate pulse to the gate lines; and
a timing controller configured to time-divide each frame of received data into n sub-frames, where n is a positive integer equal to or greater than 4, group the gate lines into n gate groups, control the gate driver to scan the n gate groups in scan sub-frames corresponding to a portion of the n sub-frames, and control a scan order of the n gate groups to scan the n gate groups in a zigzag form.

2. The display device of claim 1, wherein the gate lines are grouped into the n gate groups based on position within a block of n adjacent gate lines, the block of n adjacent gate lines comprising one or more sub-blocks of gate lines wherein one gate line is scanned in each sub-block in each of the scan sub-frames, and wherein the timing controller is further configured to control the scan order of the n gate groups in the zigzag form such that within each sub-block, a line position corresponding to a gate line being scanned alternately increases and decreases between consecutive scan sub-frames.

3. The display device of claim 1, wherein the timing controller controls the gate driver to scan the gate lines according to the scan order such that gate lines scanned in any given scan sub-frame are non-adjacent.

4. The display device of claim 1, wherein the timing controller is further configured to control the gate drive to skip a scan operation of all of the gate groups in skip sub-frames corresponding to remaining sub-frames excluding the scan sub-frames from the n sub-frames,
wherein at least one of the skip sub-frames is disposed between every adjacent scan sub-frames.

5. The display device of claim 1, wherein at least two gate groups are scanned in each of the scan sub-frames.

6. The display device of claim 1, wherein the n sub-frames include first, third, fifth, and seventh sub-frames corresponding to the scan sub-frames and second, fourth, sixth, and eighth sub-frames corresponding to skip sub-frames and the gate lines are grouped into first to eighth gate groups, and wherein the timing controller is further configured to control the gate driver to scan the second and sixth gate groups in the first sub-frame, to scan the third and seventh gate groups in the third sub-frame, to scan the first and fifth gate groups in the fifth sub-frame, and to scan the fourth and eighth gate groups in the seventh sub-frame.

7. The display device of claim 1, wherein the n sub-frames include first, third, fifth, and seventh sub-frames corresponding to the scan sub-frames and second, fourth, sixth, and eighth sub-frames corresponding to skip sub-frames and the gate lines are grouped into first to eighth gate groups, and wherein the timing controller is configured to control the gate driver to scan the third and seventh gate groups in the first sub-frame, to scan the second and sixth gate groups in the third sub-frame, to scan the fourth and eighth gate groups in the fifth sub-frame, and to scan the first and fifth gate groups in the seventh sub-frame.

8. The display device of claim 1, wherein the source driver is configured to supply the data voltages to the data lines during the scan frames and not supply the data voltages to the data lines in skip sub-frames corresponding to sub-frames other than the n scan sub-frames.

9. A method for driving a display device for low speed drive including a display panel formed with a plurality of gate lines and a plurality of data lines intersecting with the plurality of gate lines, wherein a pixel is defined by each crossing of the gate lines and the data lines, a source driver supplying data voltages to the data lines, and a gate driver supplying a gate pulse to the gate lines, the method comprising:
time-dividing each frame of received data into n sub-frames, where n is a positive integer equal to or greater than 4;
grouping the gate lines into n gate groups; and
controlling the gate driver to scan the n gate groups in scan sub-frames corresponding to a portion of the n sub-frames and controlling the scan order of the n gate groups to scan the n gate groups in a zigzag form.

10. The method of claim 1, wherein grouping the gate lines into n gate groups comprises grouping the gate lines based on position within a block of n adjacent gate lines, the block of n adjacent gate lines comprising one or more sub-blocks of gate lines wherein one gate line is scanned in each sub-block in each of the scan sub-frames, and wherein controlling the scan order of the n gate groups in the zigzag form comprises using a scan order such that such that within each sub-block, a line position corresponding to a gate line being scanned alternately increases and decreases between consecutive scan sub-frames.

11. The display device of claim 1, wherein controlling the scan order comprises scanning such that gate lines scanned in any given scan sub-frame are non-adjacent.

12. The method of claim 9, further in comprising:
skipping a scan operation of the gate lines in skip sub-frames corresponding to remaining sub-frames excluding the scan sub-frames from the n sub-frames,
wherein at least one of the skip sub-frames is disposed between every adjacent scan sub-frames.

13. The method of claim 9, wherein controlling the gate driver to dividedly scan the n gate groups in scan sub-frames comprising:
scanning at least two gate groups in each of the scan sub-frames.

14. The method of claim 9, wherein when the n sub-frames include first, third, fifth, and seventh sub-frames corresponding to the scan sub-frames and second, fourth, sixth, and eighth sub-frames corresponding to skip sub-frames and the gate lines are grouped into first to eighth gate groups, and wherein controlling the scan order of the n gate groups in the zigzag form includes:
scanning the second and sixth gate groups in the first sub-frame;
scanning the third and seventh gate groups in the third sub-frame;
scanning the first and fifth gate groups in the fifth sub-frame; and
scanning the fourth and eighth gate groups in the seventh sub-frame.

15. The method of claim 9, wherein when the n sub-frames include first, third, fifth, and seventh sub-frames corresponding to the scan sub-frames and second, fourth, sixth, and eighth sub-frames corresponding to skip sub-frames and the gate lines are grouped into first to eighth gate groups, wherein controlling the scan order of the n gate groups in the zigzag form includes:
scanning the third and seventh gate groups in the first sub-frame;
scanning the second and sixth gate groups in the third sub-frame;
scanning the fourth and eighth gate groups in the fifth sub-frame; and
scanning the first and fifth gate groups in the seventh sub-frame.

16. The method of claim 8, further comprising:
controlling an operation of the source driver in the skip sub-frames to supply the data voltages during the scan frames and to not the data voltages to the data lines during the skip frames corresponding to sub-frames other than the n scan sub-frames.

17. A display device for low speed drive comprising:
a display panel formed with a plurality of gate lines and a plurality of data lines intersecting the plurality of gate lines, wherein a pixel is defined by each crossing of the gate lines and the data lines;
a gate driver configured to supply a gate pulse to the gate lines;
a timing controller configured to receive data arranged in a sequence of frames, to time-divide a frame from the sequence of frames into a sequence of n sub-frames, wherein the n sub-frames includes a sequence of scan sub-frames interleaved with a sequence of skip sub-frames, to group the gate lines into n gate groups based on position within a block of n adjacent gate lines, the block of n adjacent gate lines comprising one or more sub-blocks of gate lines wherein the timing controller controls the gate drive to scan one gate line in each sub-block in each of the scan sub-frames, and to control the gate driver to scan the gate lines according to a scan order such that such that within each sub-block, a line position corresponding to a gate line being scanned alternately increases and decreases between consecutive scan sub-frames.

18. The display device of claim 17, wherein the gate driver does not supply the gate pulses or perform a scan operation during the skip sub-frames.

19. The display device of claim 17, further comprising:
a source driver configured to supply data voltages to the data lines during the scan sub-frames and not supply the data voltages to the data lines during the skip sub-frames.

20. The display device of claim 17, wherein the timing controller controls the gate driver to scan the gate lines according to the scan order such that gate lines scanned in any given scan sub-frame are non-adjacent.
